(19) United States
(12) Patent Application Publication
(10) Pub. No.: US 2009/0277036 A1
(43) Pub. Date: Nov. 12, 2009

(54) PEDESTAL DRYING MACHINE

(75) Inventors: Phal Jin Lee, Gyeongsangnam-do (KR); In Haeng Cho, Gyeongsangnam-do (KR); Sang Ho Park, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/310,313

(22) PCT Filed: Aug. 20, 2007
(86) PCT No.: PCT/KR2007/003957

§ 371 Date: Apr. 16, 2009

(30) Foreign Application Priority Data
Aug. 22, 2006 (KR) 10-2006-0079428

(51) Int. Cl. F26B 19/00; D06F 29/00; F26B 25/00

(52) U.S. Cl. 34/215; 68/27; 34/239

(57) ABSTRACT

A new concept drying machine, which not only functions as a pedestal for a washing machine or a drying machine, but also performs a drying function, is disclosed. The disclosed pedestal drying machine includes a container having a space for containing an object to be dried, in an interior of the container, the container allowing a laundry drying machine or a laundry washing machine to be laid on an outer top surface of the container, an air supplier for forcibly supplying air to the space, an input unit provided at the container, to receive an operating command from a user, a display unit provided at the container, to display an operation state, and a controller provided at the container, to control the air supplier based on the command from the input unit.

### TECHNICAL FIELD

The present invention relates to a pedestal drying machine, and more particularly, to a new concept drying machine not only functioning as a pedestal for a washing machine or a drying machine, but also performing a drying function.

### BACKGROUND ART

Generally, a laundry treating machine means an apparatus for washing, drying, or washing and drying laundry. One laundry treating machine can perform only a washing function or a drying function or can perform both the washing and drying functions. Recently, a laundry treating machine, which includes a steam supplier, to have a refresh function for, for example, removal of creases, odor, static electricity, etc. from laundry, has been available.

Meanwhile, conventional laundry treating machines are classified into a front loading type and a top loading type in accordance with the direction that laundry is taken out. Also, conventional laundry treating machines are classified into a vertical-axis type, in which a pulsator or a washing tub rotates, and a horizontal-axis type, in which a drum rotates. The representative example of such a horizontal-axis type laundry treating machine is a drum washing machine or a drum drying machine.

Such laundry treating machines have a tendency to have a large size, in order to meet the recent demand of users. That is, laundry treating machines used for domestic purposes have a tendency to have a large outer size.

Meanwhile, there are conventional laundry treating machines having no drying function. In association with such a laundry treating machine, which may be a washing machine, there is a problem in that, when the user wants a drying function, it is necessary to purchase a separate drying machine or a separate washing machine having a drying function. Thus, when it is desired to obtain both the washing function and the drying function, the expenses burden on the consumer must correspondingly increase.

Most conventional drying machines have a large size. For this reason, when such a drying machine is installed together with a washing machine, the installation space thereof is highly restricted.

Meanwhile, since laundry treating machines having a drying function have a tendency to have a large size, there may be a problem in terms of saving energy in that they are driven in a large capacity even when a small amount of laundry is dried.

Drum type drying machines have a problem in that they are unsuitable to dry shoes, etc. because the laundry, to be dried is tumbled in accordance with rotation of a drum.

In washing shoes, a small amount of shoes, typically, one shoe or two shoes, are washed. However, it is inefficient in terms of saving of energy to dry such a small amount of laundry, using the conventional drying machine because it is necessary to drive the drum, and to drive a high-capacity heater and a high-capacity fan.

FIG. 1 is a perspective view illustrating a conventional laundry treating machine.

As shown in FIG. 1, the conventional laundry treating machine 1 includes a body 10 forming the outer structure of the laundry treating machine 1, and a control panel 11 arranged at the front surface or top surface of the body. The control panel 11 may include a controller for controlling the operation of the laundry treating machine 1. In accordance with this configuration, the user enables the laundry treating machine 1 to perform a laundry treating operation such as a washing operation or a drying operation by manipulating the control panel 11.

The laundry treating machine 1 may be a washing machine, a drying machine, or a washing/drying machine.

The laundry treating machine 1 may further include a pedestal 20 for supporting the body 10 on a floor. In this case, the body 10 is laid on the pedestal 20.

However, the pedestal 20 does not have any function for treating laundry, other than the function for simply supporting the laundry treating machine.

### DISCLOSURE OF INVENTION

### Technical Problem

The present invention has been made in view of the above-mentioned problems, and an object of the present invention is to provide a new concept pedestal drying machine capable of not only drying a small amount of laundry, to be dried, without driving a separate laundry treating machine having a relatively-large capacity, but also functioning as a pedestal for the separate laundry treating machine, the pedestal drying machine being of a completely-dependent type such that the pedestal drying machine operates independently without being dependent on other machines, in particular, the separate laundry treating machine.

Another object of the present invention is to provide a pedestal drying machine which is of a type other than a drum type, different from conventional drying machines, such that it can save energy, reduce noise, and have a compact structure.

### Technical Solution

In one aspect of the present invention, a pedestal drying machine comprises: a container having a space for containing an object to be dried, in an interior of the container, the container allowing a laundry drying machine or a laundry washing machine to be laid on an outer top surface of the container; an air supplier for forcibly supplying air to the space; an input unit provided at the container, to receive an operating command from a user; a display unit provided at the container, to display an operation state; and a controller provided at the container, to control the air supplier based on the command from the input unit.

Preferably, the pedestal drying machine has a volume smaller than a volume of the laundry drying or washing machine, and a height shorter than a height of the laundry drying or washing machine. This is because the pedestal drying machine is adapted to perform auxiliary functions for the laundry washing or drying machine.

It is preferred that the pedestal drying machine be firmly coupled with the laundry washing or drying machine laid on the pedestal drying machine, by a coupler. This is because it is necessary to firmly support the laundry washing or drying machine on the pedestal drying machine in that vibrations are generated during rotation of a drum included in the laundry washing or drying machine.

Since the pedestal drying machine comprises the input unit, display unit, and controller, it can operate independently, without being dependent on other machines, in particular, the laundry washing or drying machine.

When the user inputs a command concerning a drying operation through the input unit, to use the pedestal drying machine, the controller controls the pedestal drying machine based on the input command. Information as to an operation state of the pedestal drying machine is displayed through the display unit.

Preferably, the air supplier comprises a blowing fan for blowing air, and a heater for heating air. When the blowing fan and heater operate simultaneously, hot air is supplied to the space. On the other hand, when only the blowing fan operates, ambient air is supplied to the space.

Preferably, the pedestal drying machine further comprises a steam supplier arranged in the container, to supply steam to the space.

Preferably, the container comprises a drawer which can be forwardly drawn. The drawer provides advantages in that it allows the user to conveniently conduct putting or taking-out of the object to be dried, and it can be easily cleaned.

The container may be provided with an air inlet formed through an upper rear wall portion of the container, and an air outlet formed through a lower rear wall portion of the container. Preferably, the drawer has an upper rear wall portion communicating with the inlet, and a lower rear wall portion communicating with the outlet.

Preferably, the heater is arranged in front of air inlet, and the blowing fan is arranged in front of air outlet.

Preferably, the air supplier and steam supplier are arranged between the rear wall of the drawer and the rear wall of the container.

The pedestal drying machine may further comprise a rack, on which an object to be dried is laid. Preferably, the rack is arranged in the drawer, to partition the interior of the drawer into upper and lower spaces communicating with each other through the rack. To communicate the upper and lower spaces, a plurality of through holes may be formed through the rack.

Preferably, the rack is inclinedly arranged. More preferably, the rack is downwardly inclined toward a position where air is introduced. In this case, accordingly, air can be uniformly supplied to the object laid on the rack.

In accordance with the inclined arrangement of the rack as described above, it is possible to more effectively dry the object, in particular, when the object is a shoe. This is because water present in the shoe flows downwardly such that it is collected.

In accordance with the inclined arrangement of the rack as described above, it is also possible to more effectively circulate air because air introduced into the drawer flows toward the lower drawer space through the through holes after striking the rack.

Preferably, the drawer is provided with an air glide formed at a rear wall of the drawer, to guide air introduced through the inlet to an upper portion of the drawer. In this case, it is possible to more effectively dry the object because air introduced into the drawer through the upper rear wall portion of the drawer is guided toward the object without immediately flowing in a downward direction.

In accordance with the present invention, it is possible to wash laundry and to dry a large amount of laundry, through the washing or drying machine laid on the pedestal drying machine. It is also possible to dry a small amount of laundry, through the pedestal drying machine. Accordingly, a convenience in use and saving of energy can be achieved.

It is also possible to easily dry laundry including shoes, hats, etc. which are difficult to be dried using a conventional drum type drying machine.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a perspective view illustrating a conventional laundry treating machine including a pedestal;

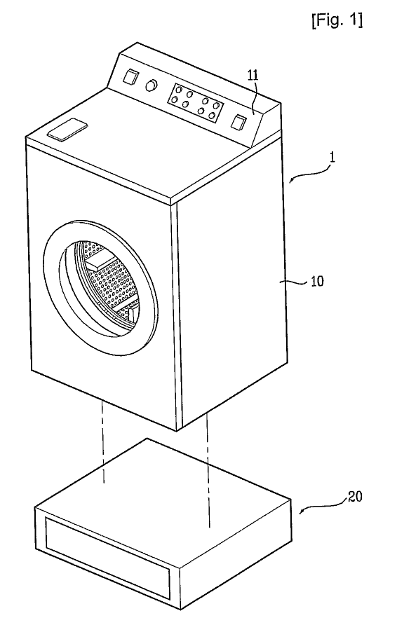

FIG. 2 is a perspective view illustrating a multiple laundry treating machine including a pedestal drying machine according to the present invention;

FIG. 3 is an exploded perspective view of the pedestal drying machine according to the present invention; and

FIG. 4 is a sectional view simply illustrating the multiple laundry treating machine, which includes the pedestal drying machine according to the present invention.

### MODE FOR THE INVENTION

The present invention now will be described more fully hereinafter with reference to the accompanying drawings, in which preferred embodiments of the invention are shown.

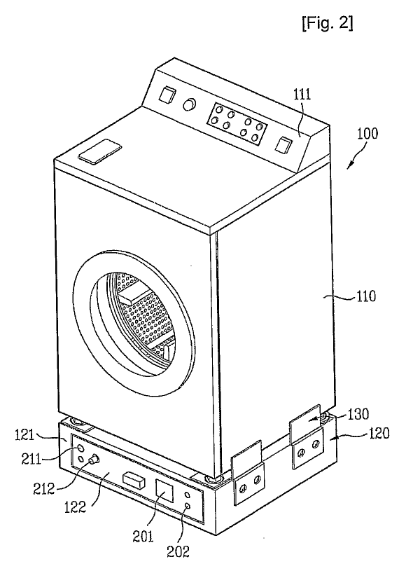

First, a pedestal drying machine according to an exemplary embodiment of the present invention will be described in detail with reference to FIGS. 2 to 4.

As shown in FIG. 2, the pedestal drying machine 120 functions as a pedestal for a body 110 of a laundry treating machine such as a washing machine or a drying machine.

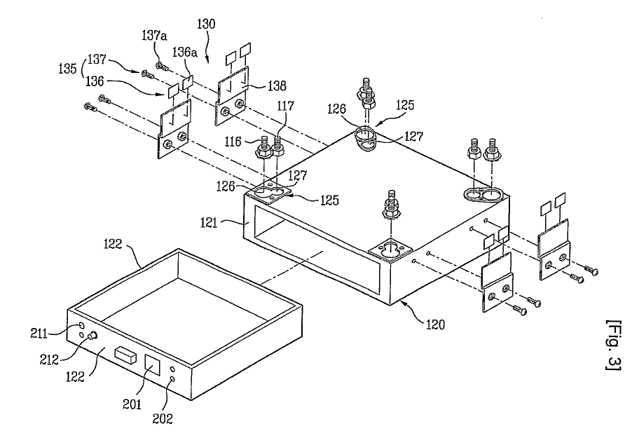

As shown in FIGS. 2 and 3, the pedestal drying machine 120 according to this embodiment includes a container 121 defined therein with a space for containing laundry, and a coupler 130 provided at the top of the container 121, to couple the container 121 and the body 110. The pedestal drying machine 120 supports the body 110 of the laundry treating machine, which may be a washing machine or a drying machine, on a floor.

The pedestal drying machine 120 may further include leg supporters 125 provided at the top of the pedestal drying machine 120, to support side surfaces of lower legs 116 and 117 mounted to the bottom of the laundry treating machine.

Each leg supporter 125 comprises a panel formed with a first seating hole 126 for providing a seat for one leg 116 included in the laundry treating machine, and a second seating hole 127 for providing a seat for one leg 117 included in the laundry treating machine. Each leg supporter 125 is mounted to the top of the container 121 of the pedestal drying machine 120 by means of screws.

The leg supporters 125 are fixed to respective corners of the top of the container 121. In each of the leg supporters 125 fixed to the front corners of the container 121, the first and second seating holes 126 and 127 are connected to each other. On the other hand in each of the leg supporters 125 fixed to the rear corners of the container 121, the first and second seating holes 126 and 127 are separated from each other. In accordance with these structures, it is possible to easily achieve the seating of the washing machine legs 116.

In each leg supporter 125, the first seating hole 126 is arranged outside the second seating hole 127 along a diagonal line on the bottom of the body 110 of the laundry treating machine. This is because, typically, the washing machine is larger than the drying machine.

The coupler 130 includes coupling members 138 each mounted to both the lower portion of a side surface of the body 110 in the laundry treating machine, which may be a washing machine or drying machine, and the upper portion of a side surface of the container 121, and fixing members 135 for fixing each coupling member 138 to both the associated side surface of the laundry treating machine body 110 and the associated side surface of the container 121.

As shown in FIG. 3, the coupler 130 may include at least two coupling members 138 each coupling the adjacent side surfaces of the container 121 and laundry treating machine body 110, each of which has a hexahedral shape.

In addition to the above-described configuration, the coupler 130 may further include a third coupling member (not shown) for coupling the rear surfaces of the container 121 and laundry treating machine body 110.

The coupler 130 may be configured to cope with a variation in the height of the washing machine legs 116 or drying machine legs 117.

Each fixing member 135 includes a first fixing member 136 for fixing an upper portion of the associated coupling member 138 to a lower portion of the side surface of the laundry treating machine body 110, namely, the washing machine body or drying machine body, to which the coupling member 138 is mounted and a second fixing member 137 for fixing a lower portion of the coupling member 138 to an upper portion of the side surface of the container 121, to which the coupling member 138 is mounted.

At least one of the first and second fixing members 136 and 137 may comprise a member coated, at opposite surfaces thereof, with an adhesive material, for example, a double-sided tape.

Alternatively, at least one of the first and second fixing members 136 and 137 may comprise a fastener such as a screw.

Where screws are used for each fixing member 135, the associated coupling member 138 preferably has fastening holes formed through the upper portion of the coupling member 138 while being spaced apart from each other by a certain distance.

Of course, the coupler for coupling the laundry treating machine body 110 and the container 121 of the pedestal drying machine 120 may have various configurations different from the above-described configuration.

In the present invention, it is preferred that the volume of the pedestal drying machine 120 be smaller than the volume of the laundry treating machine, to which the pedestal drying machine 120 is coupled. It is also preferred that the height of the pedestal drying machine 120 be shorter than the height of the laundry treating machine. To this end, it is preferred that the volume and height of the container 121 of the pedestal drying machine 120 be smaller and shorter than those of the laundry treating machine body 110, respectively. This is because the pedestal drying machine 120 is adapted to perform auxiliary functions for the laundry treating machine, which may be a drying machine or a washing machine.

It is also preferred that at least one of the lateral and longitudinal widths of the container 121 of the pedestal drying machine 120 be equal to or longer than that of the laundry treating machine, taking into consideration the stability and appearance design of a multiple laundry treating machine 100 configured as the pedestal drying machine 120 is coupled with the laundry treating machine.

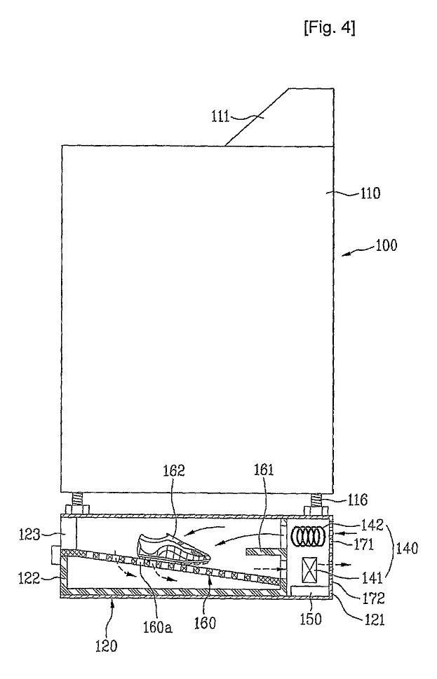

Hereinafter, the configuration of the pedestal drying machine according to the present invention will be described in detail with reference to FIG. 4.

FIG. 4 is a sectional view simply illustrating the configuration of the pedestal drying machine of the present invention.

In accordance with the present invention, the pedestal drying machine 120 is coupled to the body 110 of the laundry treating machine, to form one multiple laundry treating machine 100, which has a washing and/or drying function. In this case, the laundry treating machine receives laundry in the body 110, which forms an outer structure of the laundry treating machine, and performs a washing or drying operation for the laundry. That is, the laundry treating machine may be al washing machine, a drying machine, or a washing/drying machine.

As described above, the pedestal drying machine 120 includes the coupler 130, which couples the container 121 of the pedestal drying machine 120 to one side of the laundry treating machine body 110. The coupler 130 is not shown in FIG. 4.

The pedestal drying machine 120 is defined therein with a space for containing laundry to be dried. The laundry-containing space may have the form of a drawer 122, which can be forwardly drawn from the container 121 at the front side of the container 121. The pedestal drying machine 120 also includes an air supplier 140 arranged in the container 121, to forcibly supply air to the laundry-containing space.

The pedestal drying machine 120 further includes a steam supplier 150 arranged in the container 121, to supply steam to the laundry-containing space. The steam supplier 150 includes nozzles (not shown), to spray steam into the laundry-containing space from the top or rear side of the container 121.

The air supplier 140 and steam supplier 150 are controlled by a main control unit included in a controller 123.

The controller 123 includes an input unit and a display unit. The input unit includes a knob 212 and various select buttons 211, to achieve a selection of a desired drying course, etc. The display unit includes an LCD screen 201, and LEDs 202.

The air supplier 140 includes a blowing fan 141 for blowing air, and a heater 142 for heating air. As the blowing fan 141 operates, ambient air is introduced into the drawer 122, and is then outwardly discharged out of the drawer 122. The ambient air is introduced into the drawer 122 after being heated by the heater 142.

The heater 142 may be of various types, for example, an electric type or a gas type. Taking into consideration the installation space of the pedestal drying machine 120, it is preferred that the heater 142 be of an electric type.

Thus, the pedestal drying machine 120 according to the present invention can perform a drying function through the air supplier 140. When the blowing fan 141 and heater 142 operate simultaneously, hot air is supplied to the interior of the drawer 122. On the other hand when only the blowing fan 141 operates, ambient air is supplied to the interior of the drawer 122. It is preferred that the heater 142 be a capacity-variable heater capable of varying the temperature of air heated by the heater. This is because specific clothes exhibit a low resistance to heat, and in particular, shoes made of a rubber material exhibit a low resistance to heat.

The steam supplier 150 supplies steam to the interior of the drawer 122. The supplied steam comes into contact with laundry contained in the drawer 122, and thus performs sterilization of the laundry and removal of creases, etc. from the laundry. Thus, in accordance with the present invention, the pedestal drying machine 120 can perform a refresh function through the steam supplier 150. Of course, the above-described drying function may be carried out, together with the refresh function.

Meanwhile, it is preferred that inlets 171 be formed at an upper portion of the rear wall of the container 121, to introduce air into the container 121. Also, it is preferred that outlets 172 be formed at a lower portion of the rear wall of the container 121, to outwardly discharge air from the container 121. The rear wall of the drawer 122 communicates, at an upper portion thereof, with the inlets 171. The rear wall of the drawer 122 also communicates, at a lower portion thereof, with the outlets 172. Accordingly, ambient air is introduced into the interior of the drawer 122 via the upper rear wall portion of the container 121 and the upper rear wall portion of the drawer 122, and is then discharged from the interior of the drawer 122 via the lower rear wall portion of the drawer 122 and the lower rear wall portion of the container 121.

The blowing fan 141, which functions to generate a flow of air, and the heater 142, which heats air, may be arranged between the rear wall of the drawer 122 and the rear wall of the container 121. However, the arrangement of these elements is not limited to the above-described arrangement. The air supplier 140, which includes the blowing fan 141 and heater 142 as described above, may be arranged at any position in a path, along which air is introduced or discharged.

FIG. 4 illustrates an arrangement in which air is introduced through the upper portion of the drawer 122, and is discharged through the lower portion of the drawer 122. However, it may be possible to implement an arrangement in which air is introduced through the lower portion of the drawer 122, and is discharged through the upper portion of the drawer 122, contrary to the former arrangement.

Meanwhile, a rack 160 may be arranged in the drawer 122 such that the interior of the drawer 122 is partitioned into upper and lower spaces by the rack 160, as shown in FIG. 4. The upper and lower spaces communicate with each other through the rack 160. Laundry 162 may be laid on the rack 160. The rack 160 functions to allow air supplied to the laundry 162 to be smoothly discharged.

It is preferred that a plurality of pores 160a be formed through the rack 160. In this case, air present in the upper portion of the drawer 122 can be introduced into the lower portion of the drawer 122 through the pores 160a.

The rack 160 may also be inclinedly arranged. In this case, it is preferred that the rack 160 be downwardly inclined toward a position where air is introduced. In this case, accordingly, air can be uniformly supplied to the laundry laid on the rack 160.

Preferably, an air guide 161 is provided at the upper rear wall portion of the drawer 122. The air guide 161 not only functions to allow air to smoothly reach the front side of the drawer 122, but also functions to partition the flow paths of introduction air and discharge air. Accordingly, it is possible to minimize the interference between the introduction air and discharge air, and thus to achieve an enhancement in the operation efficiency, for example, the drying efficiency.

Using the pedestal drying machine according to the present invention, it is possible to perform various drying modes.

First, the user draws the drawer 122, and then lays laundry 162, which may be a small amount of clothes, shoes, or hats, on the rack 160. When the laundry 162 is clothes, it is desirable to spread the cloths on the rack 160.

Thereafter, the user selects a desired operation mode in accordance with the kind of the laundry, through the input unit. The operation mode may include various drying modes and a refresh mode.

The drying modes may be divided in accordance with a drying time and a drying temperature. The drying time and drying temperature may be determined in accordance with the kind of laundry. For example, when it is desired to dry a small amount of clothes made of cotton, a drying mode having a short drying time and a high drying temperature may be set. On the other hand for shoes, a drying mode having a long drying time and a low drying temperature may be set.

That is, the temperature and supply time of air forcibly supplied to the space, in which laundry is contained are varied depending on the operation mode selected by the user.

When the operation mode is the refresh mode, high-temperature steam is supplied to the laundry. Accordingly, refresh of the laundry is carried out by the steam. That is, removal of odor and creases from the laundry and sterilization of the laundry are achieved. After the completion of the refresh mode, air may be supplied to dry the laundry, if necessary.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

In accordance with the present invention, it is possible to obtain a new concept pedestal drying machine capable of not only drying a small amount of laundry, to be dried without driving a separate laundry treating machine having a relatively-large capacity, but also functioning as a pedestal for the separate laundry treating machine. It is also possible to obtain a pedestal drying machine which is of a completely-dependent type such that the pedestal drying machine operates independently without being dependent on other machines, in particular, the separate laundry treating machine.

Also, it is possible to obtain a pedestal drying machine which is of a type other than a drum type, different from conventional drying machines, such that it can save energy, reduce noise, and have a compact structure.

1. A pedestal drying machine comprising:
a container having a space for containing an object to be dried, in an interior of the container, the container allowing a laundry drying machine or a laundry washing machine to be laid on an outer top surface of the container;
an air supplier for forcibly supplying air to the space;
an input unit provided at the container, to receive an operating command from a user;
a display unit provided at the container, to display an operation state; and
a controller provided at the container, to control the air supplier based on the command from the input unit.

2. The pedestal drying machine according to claim 1, wherein the pedestal drying machine has a volume smaller than a volume of the laundry drying or washing machine, and a height shorter than a height of the laundry drying or washing machine.

3. The pedestal drying machine according to claim 1, further comprising:
a coupler provided at the top surface of the container, to couple the container and a body of the laundry drying or washing machine.

4. The pedestal drying machine according to claim 1, wherein the pedestal drying machine is a pedestal for supporting a bottom of the laundry drying or washing machine on a floor.

5. The pedestal drying machine according to claim 1, wherein the air supplier comprises a blowing fan for blowing air, and a heater for heating air.

6. The pedestal drying machine according to claim 5, wherein the container comprises a drawer for containing the object to be dried.

7. The pedestal drying machine according to claim 6, wherein:
the container is provided with an air inlet formed through an upper rear wall portion of the container, and an air outlet formed through a lower rear wall portion of the container;
the heater is arranged in front of air inlet; and
the blowing fan is arranged in front of air outlet.

8. The pedestal drying machine according to claim 7, wherein the drawer has an upper rear wall portion communicating with the inlet, and a lower rear wall portion communicating with the outlet.

9. The pedestal drying machine according to claim 8, further comprising:
a rack arranged in the drawer, to allow the object to be seated on the rack, the rack partitioning an interior of the drawer into upper and lower spaces communicating with each other through the rack.

10. The pedestal drying machine according to claim 9, wherein the rack is inclinedly arranged.

11. The pedestal drying machine according to claim 10, wherein the drawer is provided with an air guide formed at a rear wall of the drawer, to guide air introduced through the inlet to an upper portion of the drawer.

12. The pedestal drying machine according to claim 1, further comprising:
a steam supplier arranged in the container, to supply steam to the space, wherein the controller controls the steam supplier.

13. A multiple washing or drying machine comprising:
a pedestal drying machine comprising a container having a space for containing an object to be dried, in an interior of the container, the container allowing a laundry drying machine or a laundry washing machine to be laid on an outer top surface of the container, an air supplier for forcibly supplying air to the space, an input unit provided at the container, to receive an operating command from a user, a display unit provided at the container, to display an operation state, and a controller provided at the container, to control the air supplier based on the command from the input unit; and
a machine for washing or drying laundry, the laundry washing or drying machine being laid on the top surface of the container.

14. The multiple washing or drying machine according to claim 13, wherein the pedestal drying machine has a volume smaller than a volume of the laundry washing or drying machine, and a height shorter than a height of the laundry washing or drying machine.

15. The multiple washing or drying machine according to claim 13, further comprising:
a coupler provided at the top surface of the container, to couple the container and a body of the laundry washing or drying machine.

16. The multiple washing or drying machine according to claim 13, wherein the pedestal drying machine is a pedestal for supporting a bottom of the laundry washing or drying machine on a floor.
